(19) United States
(12) Patent Application Publication
(10) Pub. No.: US 2017/0093843 A1
(43) Pub. Date: Mar. 30, 2017

(54) CERTIFYING A WEBSITE

(71) Applicant: NCR Corporation, Duluth, GA (US)

(72) Inventor: Derick Douglas Schaefer, Dallas, TX (US)

(21) Appl. No.: 14/865,320

(22) Filed: Sep. 25, 2015

(51) Int. Cl. H04L 29/06

(52) U.S. Cl. CPC H04L 63/0823; H04L 63/14; H04L 63/10

(57) ABSTRACT

In a method for certifying a website to be malware-free and owned by an entity fulfilling a trust criterion, such as a chartered financial institution, a request can be received via a network. The request can specify a domain name and a site map of the domain name. A processor can validate that all Uniform Resource Locators (URLs) in the site map are devoid of malware and that the domain name is owned by a chartered financial institution. A network-accessible document can certify that the domain name and all URLs in the site map are devoid of malware and that the domain name is owned by the chartered financial institution. The URLs can be validated periodically, and the document can be updated periodically. The document can be a single XML file stored in a centralized location, and can include validations from multiple website owned by respective financial institutions.

### BACKGROUND

Performing banking or financial tasks on the internet can be convenient for consumers. These tasks can often be automated and performed by a server. As such, these tasks can be considerably faster and less expensive for financial institutions than performing comparable tasks in person or over the phone. One drawback to performing these tasks on the internet is there can be threats to online security. For instance, one or more Uniform Resource Locators (URLs) on a website can become infected with malware, which in some instances can steal confidential account information from a consumer. As another example, a website can be a fake site, which can be similar in appearance to a legitimate banking or financial website, but can also steal confidential account information from a consumer.

### SUMMARY

In a method for certifying a website, a request can be received via a network. The request can specify a domain name and a site map of the domain name. A processor can validate that all Uniform Resource Locators (URLs) in the site map are devoid of malware and that the domain name is owned by an entity fulfilling a trust criterion. The entity can be a financial institution, such as a chartered financial institution. A document can be published to a network-accessible location. The document can certify that the domain name and all URLs in the site map are devoid of malware and that the domain name is owned by the entity fulfilling the trust criterion. The URLs can be validated periodically, and the document can be updated periodically. The document can be a single XML file stored in a centralized location, and can include validations from multiple website owned by respective entities fulfilling respective trust criteria.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 shows an example of a system architecture for certifying a website to be malware-free and owned by an entity fulfilling a trust criterion, such as a chartered financial institution, in accordance with some embodiments.

FIG. 2 shows an example of a document used to certify a website to be malware-free and owned by an entity fulfilling a trust criterion, such as a chartered financial institution, in accordance with some embodiments.

FIG. 3 shows an example of a method for certifying a website to be malware-free and owned by an entity fulfilling a trust criterion, such as a chartered financial institution, in accordance with some embodiments.

FIG. 4 is a block diagram of a computing device, in accordance with some embodiments.

FIG. 5 shows an example of an XML message, in accordance with some embodiments.

### DETAILED DESCRIPTION

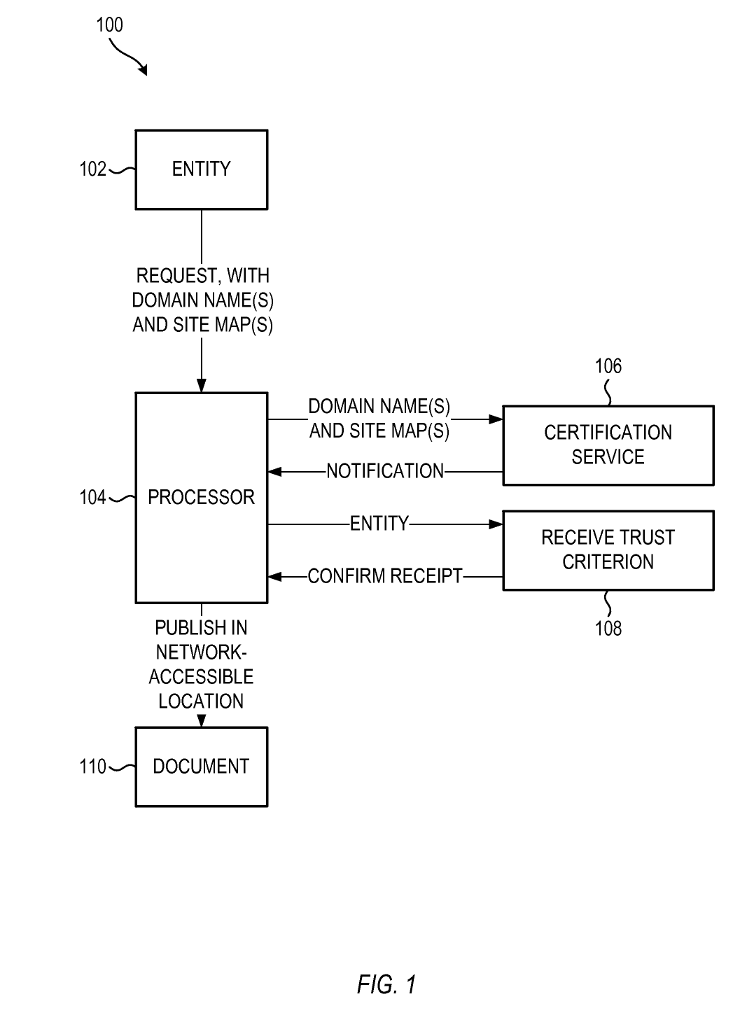

FIG. 1 shows an example of a system architecture 100 for certifying a website to be malware-free and owned by an entity fulfilling a trust criterion, in accordance with some embodiments. In some examples, the entity can be a financial institution. In some examples, the entity can be a chartered financial institution. Such certification can be provided as a Software as a Service (SaaS) by an owner and/or operator of the system architecture 100. In some examples, the owner and/or operator of the system architecture 100 can allow financial institutions, such as banks or credit unions, to register their website through the SaaS. The SaaS can confirm that the website and financial institution are legitimate, then can provide a confirmation of legitimacy to other entities, such as search engines or antivirus software, which can then safely refer users to the website.

An entity 102 fulfilling a trust criterion, such as a financial institution, such as a bank or credit union, can initiate certification of its website by submitting a request, including a domain name and a site map of the domain name, to the SaaS. In some examples, the request can further include identification of the entity itself, such as a legal name and identifying data or a link to a government-level registration site, which can be used to definitively identify the entity as an actual, government-certified entity, such as a government-certified financial institution. In some examples, the SaaS can provide a user interface on a web page to accept submissions of the requests. Other suitable submission techniques can also be used.

A processor 104 can receive the request. Processor 104 can be included in a server owned and/or operated by the SaaS. Processor 104 can validate that all Uniform Resource Locators (URLs) in the site map are devoid of malware and that the domain name is owned by the entity fulfilling the trust criterion, such as the chartered financial institution.

To assist in the search for malware, the SaaS can optionally delegate patrolling of the URLs to a certification service 106. Such a certification service 106 can be a vendor, external to the SaaS, which can scan each URL in a site map for the presence of malware. The processor 104 can communicate with the certification service 106 via a network, such as the internet. If the certification service 106 finds malware, the certification service 106 can notify the processor 104 that malware is present on the corresponding URL(s). If the certification service 106 does not find any malware, the certification service 106 can notify the processor 104 that all URLs in the site map are devoid of malware. The certification service 106 can perform scans periodically, such as at least once an hour, every half hour, or at other suitable intervals.

To assist in obtaining a trust criterion 108, such as a government-issued charter document, that confirms that the entity, such as the financial institution, is legitimate, the SaaS can optionally employ the service of an audit firm. Such an audit firm can be a vendor, external to the SaaS. The audit firm can conduct a suitable audit and prepare a suitable document that includes the result of the audit. The suitable document can certify that the entity is chartered by a certifying body, such as a government. An example of a suitable document is a Statement on Standards for Attestation Engagements (SSAE) No. 16; other suitable documents can also be used. In some examples, the suitable document is an officially issued Federal or State charter and a Form 10-K & Annual Report not to exceed fourteen months in age. The processor 104 (which may or may not be the same processor used to communicate with the certification service 106) can receive results of the audit; such results can confirm receipt of a trust criterion 108, such as a government-issued charter document, corresponding to the entity 102.

Once the website is found to be malware-free, and the entity is found to be chartered by a certifying body, such as a government, the processor 104 (which may or may not be the same processor or processors used to communicate with the certification service 106 or receive the trust criterion 108, such as a government-issued charter document) can publish a document 110 to a network-accessible location. The document 110 can certify that each domain name and all URLs in each site map are devoid of malware and that each domain name is owned by the respective chartered entity, such as a chartered financial institution. In some examples, the processor 104 can periodically refresh the document 110, to update a certification that each domain name and each site map are devoid of malware. The refreshing can occur at least once an hour, or at other suitable regular or non-regular time intervals.

The document 110 can be accessible, via a network such as the internet, and can assure those who access it that a particular URL or website listed in the document is malware-free and owned by an entity fulfilling a trust criterion, such as a chartered financial institution.

In general, when a denovo bank is initially formed or when another bank is acquired, the proposed bank can complete a charter application for at least two regulating agencies. The charter application can include extensive information about the organizer(s), a business plan, a senior management team, a board of directors, finances, capital adequacy and funding source, risk management infrastructure, market analysis, and other relevant factors. The proposed bank can first receive approval for a federal or state charter. The Office of the Comptroller of the Currency (OCC) can have exclusive authority to issue a federal or national bank charter. Any state can issue a state charter. Before granting a charter, the OCC or state can determine that the proposed bank has a reasonable chance for success and can operate in a safe and sound manner. The proposed bank can obtain approval for deposit insurance from the Federal Deposit Insurance Corporation (FDIC). The Federal Reserve can require additional approvals if the proposed bank wishes to become a member of the Federal Reserve. Regulators can require notification if a bank varies significant new lines of business, funding sources, and other elements from the bank's original business plans or operations. In some instance, regulators can request a new charter and application if the variations are sufficiently significant.

Chartered financial institutions can issue monthly reports, such as Bank Secrecy Act (BSA)/Anti-Money Laundering (AML) Report including Suspicious Activity Reports (SAR), and Regulation D: Required Reserves Report, and others. Chartered financial institutions can issue quarterly reports, such as Affiliated Transaction Report, Appraisal Certification, Community Reinvestment Act (CRA), Consolidated Report of Condition and Income (Call Report), Criticized Asset Report (CAR), Designation of Regulation O Officers, Form 10-Q, High Risk Customer Transaction Monitoring Report, Interest Rate Risk Report, Internal Asset Review Report, Regulation O Report, Report of Condition/Financial Performance Report, and others. Chartered financial institutions can issue annual reports, such as Bank Protection Act (BPA) Security Program Report, Form 10-K & Annual Report, Graham Leach-Bliley Act Report (GLBA), Home Mortgage Disclosure Act (HDMA) Loan Application Register (LAR), and others.

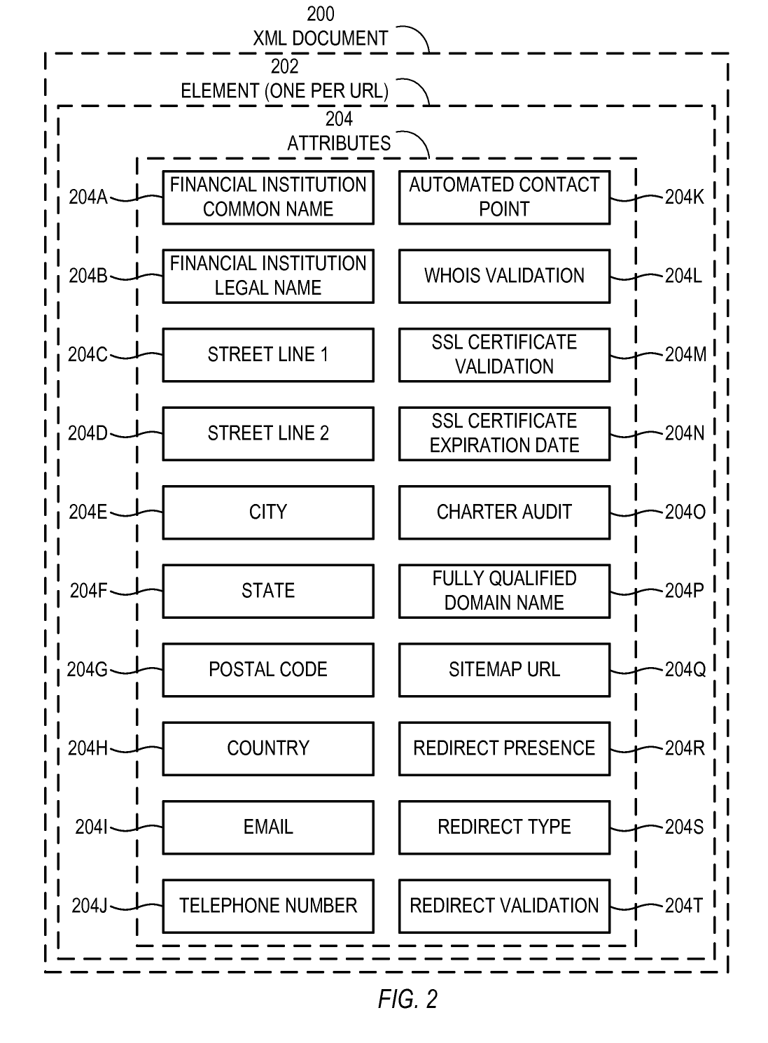

FIG. 2 shows an example of a document 200 used to certify a website to be malware-free and owned by an entity fulfilling a trust criterion, such as a chartered financial institution, in accordance with some embodiments. The document 200 of FIG. 2 is but one example, and is directed to the specific case of the entity being a chartered financial institution; other suitable documents can also be used.

Document 200 can include certification information for multiple websites, which can be owned and/or operated by multiple financial institutions. A search engine company, an antivirus company, or another suitable customer can access the document 200 to check the validity and/or safety of particular website, to ensure that the website is malware-free and owned by a chartered financial institution.

In some examples, document 200 can be generated dynamically by one or more processors in a system, such as 100 (FIG. 1). In other examples, document 200 can be generated statically by one or more processors in a system, such as 100 (FIG. 1), and stored on one or more servers in the system. In some examples, document 200 can be posted, or dynamically generated, so as to be accessible and/or downloadable via a network, such as the internet. In other examples, document 200 can be generated and pushed to one or more locations outside of system 100.

In the example of FIG. 2, document 200 can be in Extensible Markup Language (XML). In other examples, other suitable data structures or formats can also be used.

In the example of FIG. 2, document 200 can include one or more elements 202, with each element 202 corresponding to a corresponding URL in a particular site map. Document 200 can include similar sets of elements 202 for all the URLs in multiple site maps, for respective multiple websites.

In the example of FIG. 2, each element 202 can include one or more attributes 204 corresponding to various aspects of a respective website and corresponding financial institution. Many attributes 204 and combinations of attributes 204 can be used; several examples of attributes 204 are described below. Attributes 204 can have corresponding formats, such as text, numeric, boolean, date, URL, or other suitable formats. Attributes can also have corresponding values, in the corresponding format.

In some examples, each element 202 can include attributes 204 corresponding to common and legal names of the chartered financial institution. In the example of FIG. 2, attribute 204A is a financial institution common name, with a format of text, and a value, such as “Homer's National Bank”. In the example of FIG. 2, attribute 204B is a financial institution legal name, with a format of text, and a value, such as “Homer's National Bank & Trust LLP”.

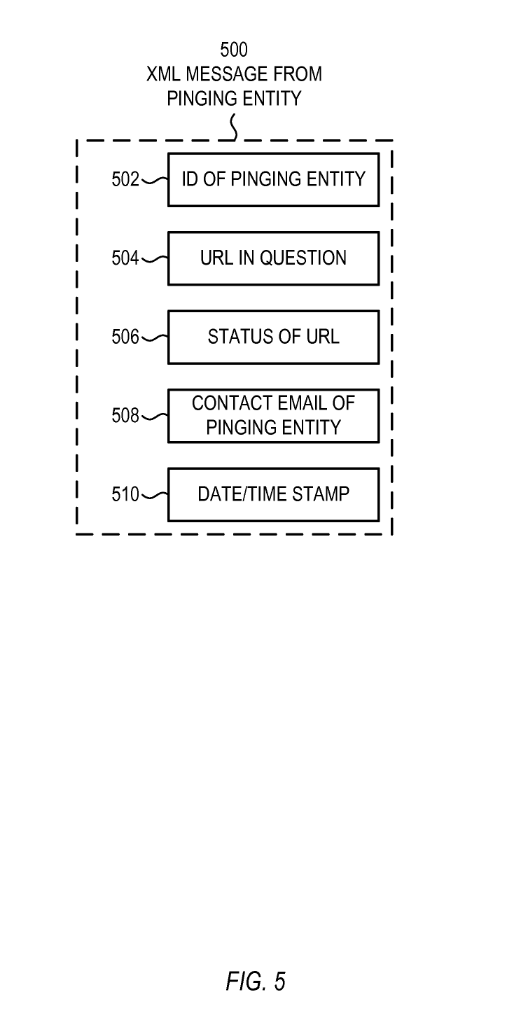

In some examples, each element 202 can include attributes 204 corresponding to counsel contact information at the chartered financial institution. The financial institution can provide these attributes 204 to an owner/operator of system 100 (FIG. 1). A customer, a financial institution, a search engine company, an antivirus company, or any other suitable entity can use the counsel contact information to contact the respective financial institution to report an instance that their website has been flagged for phishing or other malware, or contact the financial institution for any suitable reason. In some examples, the counsel contact information can include at least one of a physical address, an email address, a telephone number, and an automated contact point. In some examples, the automated contact point, also referred to as endpoint, can allow an entity, such as search engine, to ping the automated contact point and automatically receive the suitable counsel contact information. Such a ping can indicate that the pinging entity has found something potentially troubling on a particular URL associated with the financial entity, such as potential malware or phishing. In some examples, such as the example shown in FIG. 5, the ping can include an XML message 500 that can include at least one of an identification of a pinging entity 502 (such as a search engine, a malware company, a public watch site, and others), the URL in question 504, a status 506 of the URL (such as good, potential malware detected, or potential phishing page), a contact email address 508 of the notifying party (e.g., the entity sending the ping), and a date stamp or time stamp 510.

Returning to the example of FIG. 2, attribute 204C is a street line 1, with a format of text, and a value, such as “742 Evergreen Terrace”. In the example of FIG. 2, attribute 204D is a street line 2, with a format of text, and a value, such as “Attn: Marge”. In the example of FIG. 2, attribute 204E is a city, with a format of text, and a value, such as “Springfield”. In the example of FIG. 2, attribute 204F is a state, with a format of text, and a value, such as “Georgia”. In the example of FIG. 2, attribute 204G is a postal code, with a format of text, and a value, such as “31329”. In the example of FIG. 2, attribute 204H is a country, with a format of text, and a value, such as “United States”. In the example of FIG. 2, attribute 204I is an email, with a format of text, and a value, such as “chunkylover53@aol.com”. In the example of FIG. 2, attribute 204J is a telephone number, with a format of text, and a value, such as “900-555-7334”. In the example of FIG. 2, attribute 204K is an automated contact point, with a format of URL, and a value, such as “http://www.homersnationalbank.com/doh”. Attributes 204C-K are but nine examples; other suitable include attributes 204 corresponding to counsel contact information at the chartered financial institution can also be used.

In some examples, each element 202 can include an attribute 204 corresponding to a query and response protocol that stores registered users or assignees of an Internet resource, such as a domain name, an IP address block, or an autonomous system. In the example of FIG. 2, attribute 204L is a WHOIS validation, with a format of boolean, and a value of true. Other validations can also be used.

In some examples, each element 202 can include attributes 204 corresponding to security certificates, such as those used for protocols such as Secure Sockets Layer (SSL) and Transport Layer Security (TLS). For instance, these attributes can confirm the presence of, and expiration date of, a suitable security certificate of a domain name. In the example of FIG. 2, attribute 204M is an SSL certificate validation, with a format of boolean, and a value of true. In the example of FIG. 2, attribute 204N is an SSL certificate expiration date, with a format of date, and a value of Jul. 30, 2016.

In some examples, each element 202 can include an attribute 204 corresponding to confirmation of an audit of a charter of the financial institution. Such an audit can be carried out by the owner/operator of system 100 (FIG. 1), or by a suitable external entity. In some examples, such an audit can be conducted by hand, using physical documents provided by the financial institution. In some examples, such an audit can be a Statement on Standards for Attestation Engagements (SSAE) No. 16. In the example of FIG. 2, attribute 204O is a charter audit, with a format of boolean, and a value of true.

In some examples, each element 202 can include an attribute 204 corresponding to confirmation that all URLs in the site map are devoid of malware. Such a confirmation can be provided by the owner/operator of system 100 (FIG. 1), or by a suitable external entity that can scan the URLs for malware. Malware can include software intended to damage or disable computers and/or computer systems. Malware can include phishing schemes, intended to steal costumer's confidential information, such as account numbers and passwords. In the example of FIG. 2, attribute 204O is a malware-free validation, with a format of boolean, and a value of true.

In the example of FIG. 2, each element can include an attribute 204P corresponding to a fully qualified domain name (FQDN), with a format of text, and a value, such as “donuts.homersnationalbank.com”. In the example of FIG. 2, each element can include an attribute 204Q corresponding to a site map of the FQDN, with a format of URL, and a value, such as “homersnationalbank.com/sitemap”.

In some examples, each element 202 can include attributes 204 corresponding to redirects in the site map. In the example of FIG. 2, attribute 204R can correspond to existence of any redirects in the site map, with a format of boolean, and a value of true. In the example of FIG. 2, attribute 204S can correspond to a type of redirect in the site map, with a format of numeric, and values that can correspond to states of permanent or temporary. In the example of FIG. 2, attribute 204T can correspond to confirmation that the redirects in the site map are valid, with a format of boolean, and a value of true.

Attributes 204A-T are but examples; any suitable attributes can also be used.

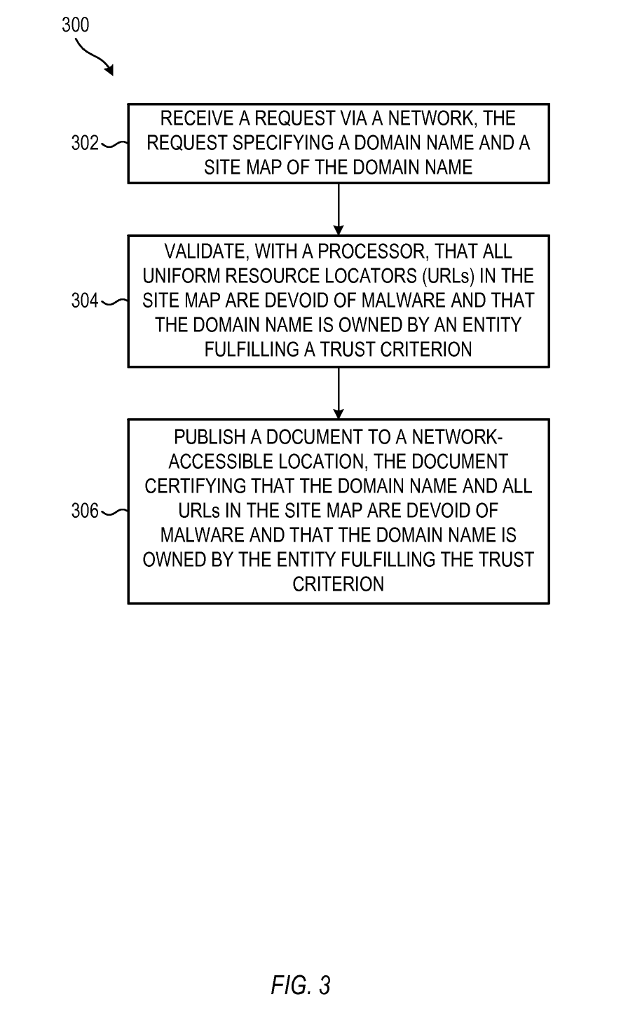

FIG. 3 shows an example of a method 300 for certifying a website to be malware-free and owned by an entity fulfilling a trust criterion, such as a chartered financial institution, in accordance with some embodiments. Method 300 can be executed on a system, such as 100 (FIG. 1) having a processor, such as 104 (FIG. 1). Method 300 is but one example of a method for certifying a website to be malware-free and owned by an entity fulfilling a trust criterion, such as a chartered financial institution; other suitable methods can also be used.

At operation 302, one or more requests can be received via a network. The one or more requests can each specify a domain name and a site map of the domain name.

At operation 304, a processor can validate that all Uniform Resource Locators (URLs) in each site map are devoid of malware and that each domain name is owned by a respective an entity fulfilling a trust criterion, such as a chartered financial institution. In some examples, at operation 304, the processor can periodically validate that all URLs in each site map are devoid of malware.

In some examples, operation 304 can optionally further include sending each domain name and each site map, via a network, to a certification service. In some examples, operation 304 can optionally further include receiving notification from the certification service, via the network, that the certification service certifies that all URLs in each site map are devoid of malware. In some examples, the notification can be periodic, such as at least once an hour.

At operation 306, a document can be published to a network-accessible location. The document can certify that each domain name and all URLs in each site map are devoid of malware and that each domain name is owned by the respective entity fulfilling the trust criterion, such as a chartered financial institution. In some examples, operation 306 can periodically refresh the document, and publish the refreshed document, to update a certification that each domain name and each site map are devoid of malware. In some examples, operation 306 can periodically refresh the document and publish the refreshed document. The refreshing can occur at least once an hour, or at other suitable regular or non-regular time intervals.

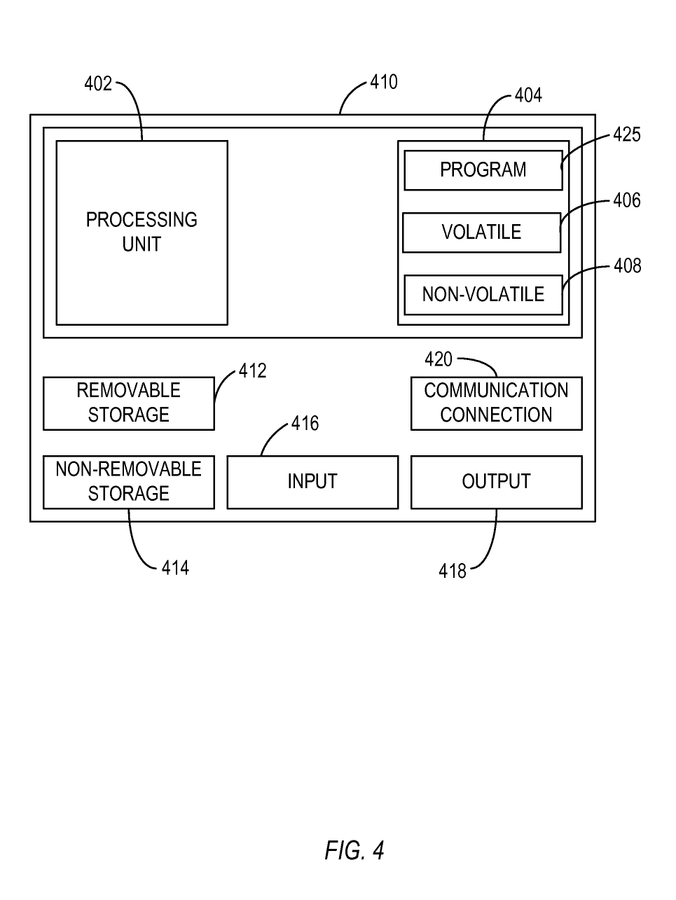

FIG. 4 is a block diagram of a computing device, in accordance with some embodiments. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408. Computer 410 may include, or have access to a computing environment that includes, a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD-ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a non-transitory computer-readable medium. For example, a computer program 425 capable of certifying a website to be malware-free and owned by an entity fulfilling a trust criterion according to the teachings of the present invention may be included on a CD-ROM and loaded from the CD-ROM to a hard drive. The computer-readable instructions allow computer 410 to provide generic access controls in a COM based computer network system having multiple users and servers.

What is claimed is:

1. A method, comprising:
receiving a request via a network, the request specifying a domain name and a site map of the domain name;
validating, with a processor, that all Uniform Resource Locators (URLs) in the site map are devoid of malware and that the domain name is owned by an entity fulfilling a trust criterion; and
publishing a document to a network-accessible location, the document certifying that the domain name and all URLs in the site map are devoid of malware and that the domain name is owned by the entity fulfilling the trust criterion.

2. The method of claim 1, wherein validating, with the processor, that all URLs in the site map are devoid of malware and that the domain name is owned by an entity fulfilling a trust criterion comprises:
sending the domain name and the site map, via a network, to a certification service; and
receiving notification from the certification service, via the network, that the certification service certifies that all URLs in the site map are devoid of malware.

3. The method of claim 2, further comprising:
periodically validating, with a processor, that all URLs in the site map are devoid of malware;
periodically refreshing the document to update a certification that the domain name and the site map are devoid of malware; and
publishing the refreshed document to the network-accessible location, the refreshed document certifying that the domain name and all URLs in the site map are devoid of malware and that the domain name is owned by the entity fulfilling the trust criterion.

4. The method of claim 3, wherein periodically refreshing the document to update the certification that the domain name and the site map are devoid of malware comprises:
receiving periodic notification from the certification service, via the network, including updated certification from the certification service that all URLs in the site map are devoid of malware; and
refreshing the document at least once an hour to update the certification that the domain name and the site map are devoid of malware.

5. The method of claim 4, wherein receiving periodic notification from the certification service, via the network, including updated certification from the certification service that all URLs in the site map are devoid of malware comprises:
receiving notification at least once an hour from the certification service, via the network, including updated certification from the certification service that all URLs in the site map are devoid of malware.

6. The method of claim 1,
wherein the entity is a chartered financial institution and the trust criterion is a charter of the financial institution; and
wherein validating, with the processor, that all URLs in the site map are devoid of malware and that the domain name is owned by an entity fulfilling a trust criterion comprises:
confirming receipt, with the processor, of a government-issued charter document corresponding to a financial institution.

7. The method of claim 1, wherein the document is in Extensible Markup Language (XML) and is accessible via a network.

8. The method of claim 7, wherein the XML document includes an element corresponding to each URL in the site map.

9. The method of claim 8, wherein each element includes attributes corresponding to common and legal names of the entity fulfilling the trust criterion.

10. The method of claim 8, wherein each element includes at least one attribute corresponding to counsel contact information at the entity fulfilling the trust criterion.

11. The method of claim 9, wherein the counsel contact information includes at least one of a physical address, an email address, a telephone number, and an automated contact point.

12. The method of claim 8, wherein each element includes attributes that:
indicate validity of a security certificate of the domain name; and
indicate an expiration date of the security certificate.

13. The method of claim 8, wherein each element includes an attribute corresponding to confirmation of an audit of a trust criterion of the entity.

14. The method of claim 8, wherein each element includes an attribute corresponding to confirmation that all URLs in the site map are devoid of malware.

15. The method of claim 8, wherein each element includes attributes corresponding to a fully qualified domain name (FQDN) and a URL corresponding to a site map of the FQDN.

16. The method of claim 8, wherein each element includes at least one attribute corresponding to redirects in the site map.

17. A method, comprising:
receiving requests via a network, the requests specifying a plurality of domain names and a respective plurality of site maps of the plurality of domain names;
validating, with a processor, that all Uniform Resource Locators (URLs) in each of the plurality of site maps are devoid of malware and that each of the plurality of domain names is owned by a respective entity fulfilling a trust criterion; and
publishing a document to a network-accessible location, the document certifying that:
each of the plurality of domain names and each of the plurality of site maps are devoid of malware; and
each of the plurality of domain names is owned by a respective entity fulfilling a respective trust criterion.

18. The method of claim 17, further comprising:
periodically validating, with a processor, that all URLs in each of the plurality of site maps are devoid of malware;
periodically refreshing the document to update a certification that each of the plurality of domain names and each of the plurality of site maps are devoid of malware; and
publishing the refreshed document to the network-accessible location, the refreshed document certifying that:
each of the pluralities of domain names and each of the plurality of site maps are devoid of malware; and
each of the plurality of domain names is owned by the respective entity fulfilling the respective trust criterion.

19. A system, comprising:
a network interface device;
at least one processor; and
at least one memory device storing instructions executable by the at least one processor, the instructions being executable by the at least one processor to perform data processing activities, the data processing activities comprising:
receiving requests through the network interface device, the requests specifying a plurality of domain names and a respective plurality of site maps of the plurality of domain names;
validating, with the at least one processor, that all Uniform Resource Locators (URLs) in each of the plurality of site maps are devoid of malware and that each of the plurality of domain names is owned by a respective entity fulfilling a respective trust criterion; and
publishing a document to a network-accessible location, the document certifying that:
each of the plurality of domain names and each of the plurality of site maps are devoid of malware; and
each of the plurality of domain names is owned by a respective entity fulfilling a respective trust.

20. The system of claim 19, wherein the data processing activities further comprise:
periodically validating, with the at least one processor, that all URLs in each of the plurality of site maps are devoid of malware;
periodically refreshing the document to update a certification that each of the plurality of domain names and each of the plurality of site maps are devoid of malware; and
publishing the refreshed document to the network-accessible location, the refreshed document certifying that:
each of the pluralities of domain names and each of the plurality of site maps are devoid of malware; and
each of the plurality of domain names is owned by the respective entity fulfilling the respective trust criterion.
